(19) United States
(12) Patent Application Publication
(10) Pub. No.: US 2017/0347068 A1
(43) Pub. Date: Nov. 30, 2017

(54) IMAGE OUTPUTTING APPARATUS, IMAGE OUTPUTTING METHOD AND STORAGE MEDIUM

(71) Applicant: CANON KABUSHIKI KAISHA, Tokyo (JP)

(72) Inventor: Hiroshi KUSUMOTO, Kokubunji-shi (JP)

(21) Appl. No.: 15/606,506

(22) Filed: May 26, 2017

(30) Foreign Application Priority Data
May 27, 2016 (JP) 2016-106365

(51) Int. Cl. H04N 7/18; G08B 13/196

(52) U.S. Cl. CPC H04N 7/183; G08B 13/19669; H04N 7/188

(57) ABSTRACT

An image outputting apparatus comprises: a first accepting unit which accepts an output instruction of a captured image; and an outputting unit which outputs, in a case where, in the captured image captured at a first time point, a predetermined event occurs and the output instruction is accepted at a second time point after the occurrence of the predetermined event and the predetermined event is continuing at the second time point, the captured image captured by an imaging unit at and after the second time point, and outputs, in a case where the output instruction is accepted at the second time point and the predetermined event does not continue at the second time point, the captured image captured during the continuation of the predetermined event.

### BACKGROUND OF THE INVENTION

### Field of the Invention

The present invention relates to an image outputting apparatus, an image outputting method, and a storage medium for storing a program related to the image outputting apparatus and method.

### Description of the Related Art

Conventionally, there has been known a delivery system which delivers a camera image by using an IP (Internet Protocol) network such as the Internet or the like. The delivery system like this has been adopted for Internet sites of delivering the situations of ski resorts, zoos and the like, and also adopted for surveillance of shops, buildings and the like. Besides, in recent years, there has been also known a technique of, when an event occurs, notifying the occurrence of the event to a user who is not in front of a surveillance terminal, by using an e-mail, an event notification to a user's portable terminal, or the like. Here, Japanese Patent Application Laid-Open No. 2010-258704 discloses the technique of providing the recording function and the moving body detecting function in a camera, displaying, in a case where an event such as detection of leaving-behind or detection of carrying-away occurs, the timeline at the time of the occurrence of the event, and calling the video image recorded at the time of the occurrence of the event.

When a predetermined event occurs, for example, when an intruder is detected in a camera image captured by a camera, a user connects to the camera from the mobile terminal of the user own, and confirms the video image related to the predetermined event. However, there is a case where, when the mobile terminal accepts an event occurrence notification from the camera and thus the user connects to the camera, the intruder has already disappeared from the camera image. In the case like this, there is a problem that the event such as the intrusion of the intruder or the like cannot be confirmed in the camera image.

### SUMMARY OF THE INVENTION

In order to output, when a predetermined event occurs, a captured image suitable for confirming the event, for example, the following constitution is provided.

That is, there is provided an image outputting apparatus which comprises: a first accepting unit configured to accept an output instruction of a captured image captured by an imaging unit; and an outputting unit configured to, in a case where, in the captured image captured at a first time point, the output instruction is accepted at a second time point after occurrence of a predetermined event and the predetermined event is continuing at the second time point, output the captured image captured by the imaging unit at and after the second time point, and, in a case where the output instruction is accepted at the second time point and the predetermined event does not continue at the second time point, output the captured image captured during the continuation of the predetermined event.

Further features of the present invention will become apparent from the following description of exemplary embodiments with reference to the attached drawings.

### BRIEF DESCRIPTION OF THE DRAWINGS

FIG. 1 is a diagram for describing an imaging system as a whole.

FIG. 2 is a block diagram for describing the hardware constitution of an imaging device.

FIG. 3 is a functional block diagram of an imaging device.

FIG. 4 is a diagram indicating a display example of a terminal device.

FIG. 5 is a block diagram for describing the constitution of the terminal device.

FIG. 6 is a flow chart for describing a state determining process.

FIG. 7 is an explanatory diagram of the state determining process.

FIGS. 8A, 8B, 8C and 8D are explanatory diagrams of a continuation determination condition.

FIG. 9 is a flow chart for describing a delivering process.

FIGS. 10A, 10B, 10C and 10D are explanatory diagrams of the continuation determination condition.

FIGS. 11A and 11B are explanatory diagrams of the continuation determination condition.

### DESCRIPTION OF THE EMBODIMENTS

Hereinafter, preferred embodiments of the present invention will be described with reference to the accompanying drawings.

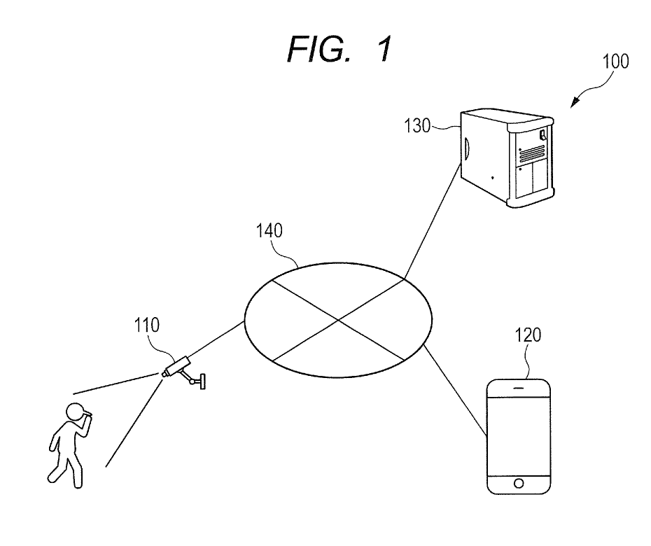

An embodiment of the present invention will be described hereinafter with reference to the drawings. FIG. 1 is a diagram for describing the overall configuration of an imaging system 100 according to the embodiment. The imaging system 100 according to the present embodiment comprises an imaging device 110, a terminal device 120 to be used by a user, and a VMS (video management system) 130. The imaging device 110, the terminal device 120 and the VMS 130 are mutually connected via a network 140.

The imaging device 110, which serves as a surveillance (or watching) camera, is installed on, for example, a wall surface or a ceiling, thereby obtaining a captured (or photographed) image in a surveillance area. In the present embodiment, it is assumed that the imaging device 110 captures a moving image as the captured image. As another example, the imaging device 110 may capture a still image as the captured image. For example, the imaging device 110 may periodically capture the still image every few seconds or the like. The imaging device 110 can deliver the obtained captured image to the terminal device 120 and the VMS 130 via the network 140. Moreover, the imaging device 110 detects, by analyzing the captured image, a predetermined event such as intrusion of a suspicious individual, passage of a suspicious individual, carrying-away of an object, leaving-behind of an object, or the like. Moreover, the imaging device 110 analyzes an input from a sensor such as a microphone, a contact input, or the like, and detects an abnormality based on the analyzed input. Incidentally, the imaging device 110 is an example of an image outputting device.

The terminal device 120 serves as an information processing device. In the present embodiment, it is assumed that the terminal device 120 is a portable terminal device. However, as another example, the terminal device may be a PC (personal computer) or the like. Also, the terminal device 120 may be a smartphone or the like to be used via a telephone line. The terminal device 120 requests the imaging device 110 or the VMS 130 to deliver the captured image, and reproduces and displays the captured image received from the imaging device 110 or the VMS 130. It should be noted that the VMS 130 is an information processing device. More specifically, the VMS 130 receives the captured image from the imaging device 110, and delivers and records the captured image.

In the present embodiment, the imaging device 110, the VMS 130 and the terminal device 120 perform communication defined by the imaging device 110. The network 140 is configured by a plurality of routers, switches, cables and the like which satisfy the communication standard such as Ethernet (registered trademark) or the like. Here, it should be noted that the network 140 may be any communication standard, scale or configuration as long as it can perform communication among the imaging device 110, the terminal device 120 and the VMS 130. For example, the network 140 may be configured by any of the Internet, a wired LAN (local area network), a wireless LAN, a WAN (wide area network), a telephone communication line and the like. Incidentally, for example, the imaging device 110 in the present embodiment may correspond to PoE (Power Over Ethernet (registered trademark)), and may be supplied with power via a LAN cable.

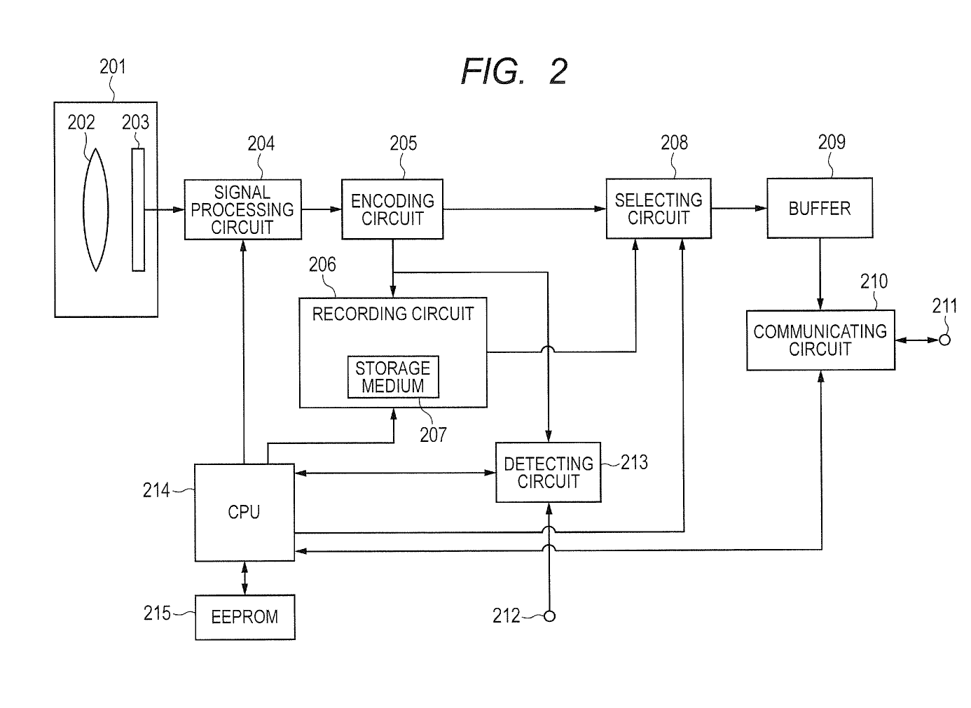

FIG. 2 is a block diagram for describing an example of the hardware constitution of the imaging device 110 according to the present embodiment. An imaging unit 201 comprises a front lens 202 and an imaging element 203 in an imaging optical system. Here, video image light from the front lens 202 enters the imaging element 203 and is photoelectrically converted. Further, the hardware constitution includes a signal processing circuit 204, an encoding circuit 205 which converts a video image signal into a video image of, e.g., a JPEG (Joint Photographic Experts Group) format, and a recording circuit 206 which records a captured image on a storage medium 207 such as an SD (secure digital) card. The recording circuit 206 performs control so that the video images obtained from a process time point to a predetermined time before are always recorded on the storage medium 207.

The hardware constitution further includes a selecting circuit 208 which selects, as a target to be delivered (called a delivery target hereinafter), either one of a captured image directly input from the encoding circuit 205, i.e., a live video image, and a captured image stored in the storage medium 207, i.e., a recorded video image.

The hardware constitution further includes a buffer 209, a communicating circuit 210, a communication terminal 211, a sensor inputting unit 212 such as a contact input, a microphone or the like, and a detecting circuit 213. The detecting circuit 213 detects occurrence of the predetermined event such as intrusion or the like, based on the captured image and a signal from the sensor inputting unit 212. Incidentally, the sensor such as the microphone or the like is to detect an environmental change in an area using an imaging range of the imaging unit 201 as a reference, and is an example of a detecting unit. The hardware constitution further includes a central arithmetic processing circuit (hereinafter, called a CPU (central processing unit)) 214, and an electrically erasable nonvolatile memory (an EEPROM (electrically erasable programmable read only memory)) 215. Incidentally, it should be noted that later-described functions and processes of the imaging device 110 are realized on the premise that the CPU 214 reads out programs stored in the nonvolatile memory 215 and executes the read programs.

When a capturing (imaging) operation is performed by the imaging unit 201, the signal processing circuit 204 outputs the luminance signal and the color difference signal from the imaging element 203 to the encoding circuit 205, in response to an instruction from the CPU 214. Then, the video signal encoded and obtained by the encoding circuit 205 is recorded on the storage medium 207 by the recording circuit 206 in response to an instruction from the CPU 214. In addition, the encoded video signal is output to the selecting circuit 208. The selecting circuit 208 selects the recorded video image or the live video image in response to an instruction from the CPU 214. The video image (recorded video image or live video image) selected by the selecting circuit 208 is transmitted to the outside via the buffer 209, the communicating circuit 210, and the communication terminal 211.

The detecting circuit 213 detects the occurrence of various events, based on a result of the motion of the video image from the video image signal output from the encoding circuit 205, and the signal from the sensor. For example, when a pre-registered registration event occurs, the detecting circuit 213 detects the state of the sensor, and outputs notification information indicating the occurrence of the registration event to the CPU 214. Incidentally, in the detecting circuit 213 of the present embodiment, it is assumed that intrusion detection of a moving body such as a car, a person or the like, passage detection of the moving body, leaving-behind detection of an object such as a bag, a person or the like, and carrying-away detection of the object are set as the registration event.

Further, the detecting circuit 213 detects, in addition to the registration event, a related event which is related to the registration event. Incidentally, it is assumed that, in the detecting circuit 213, the related events are previously set for each of the registration events. Besides, it is assumed that, in the detecting circuit 213, moving body detection and detected object tracking (position confirmation) are set as the related events. Hereinafter, the related event will be described. When the registration event “carrying-away detection” occurs, even after the carrying-away detection is completed, the person who carried the object away is shown (or included) in the captured image. In this case, the video image of the person who carried the object away is likely to become an important video image related to the carrying-away. In this way, the event occurring in relation to the registration event is set as the related event. That is, “detection of the person who carried the object away” is set as the related event of the registration event “carrying-away detection”.

Incidentally, it is assumed that the registration event and the related event are previously set in the detecting circuit 213 by a designer or the like, and it is also assumed that these events can be appropriately changed. The number, kind and the like of the registration event and the related event set in the detecting circuit 213 are not limited to those described in the present embodiment. Specific examples of the registration event and the related event will later be described in detail.

When the notification information is input from the detecting circuit 213, the CPU 214 transmits a registration event occurrence notification (for example, an alert) to the terminal device 120 via the communicating circuit 210 and the communication terminal 211. Incidentally, it is assumed that the IP (Internet Protocol) address or the like of the terminal device 120 to which the occurrence notification is to be transmitted is set in the imaging device 110. Besides, it may be possible to constitute that an electronic mail address or the like is registered in the imaging device 110, and the occurrence notification is transmitted from the imaging device to the destination of the relevant mail address. For example, in response to the reception of the occurrence notification by the terminal device 120, a user of the terminal device 120 browses the captured image captured by the imaging device 110. Furthermore, when the registration event is detected, the CPU 214 controls the recording circuit 206 to start recording the captured image from the time point earlier, by a predetermined specific time of, for example, ten seconds, than the time point of the occurrence of the detected registration event, to the storage medium 207.

FIG. 3 is a functional block diagram of the imaging device 110. A determining unit 301 determines whether or not a registration event occurs, based on the detection result of the detecting circuit 213. Further, after the occurrence of the registration event, the determining unit 301 determines whether or not the registration event is continuing, based on the detection result of the detecting circuit 213. A recording processing unit 302 instructs the recording circuit 206 to start image recording based on the determination result of the determining unit 301. An accepting unit 303 accepts information such as an instruction input by the user in the terminal device 120, via the communicating circuit 210. An output processing unit 304 decides which of the live video image and the recorded video image is to be selected as the captured image, based on the occurrence of the registration event and continuation situation of the registration event, and then issues a selection instruction to the selecting circuit 208.

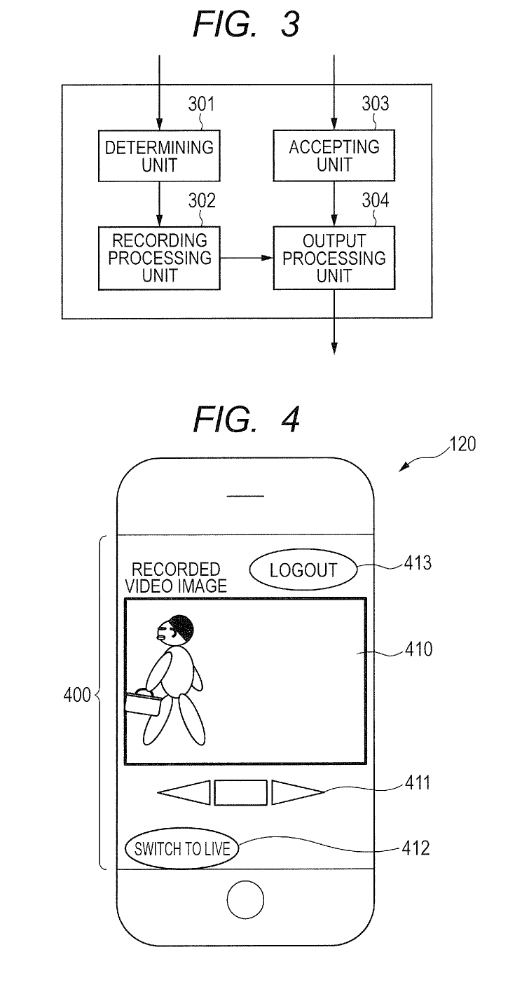

FIG. 4 is a diagram indicating a display example of the terminal device 120. In a video image area 410 of a displaying unit 400, the captured image (the live video image or the captured video image) delivered from the imaging device 110 is displayed. Operation buttons 411 are an operation unit for instructing stopping, rewinding and fast-forwarding of the video image, and a kind of video image is displayed when the recorded video image is displayed. An operation button 412 is an operation button for switching the kind of video image. When the video image which is being displayed in the video image area 410 is the recorded video image, the operation button 412 is displayed as the button for switching to the live video image. On the other hand, when the video image which is being displayed in the video image area 410 is the live video image, the operation button 412 is displayed as the button for switching to the recorded video image. When the operation button 412 for switching to the recorded video image is pressed, a list of the recorded video images (not illustrated) is displayed. Thus, the user can select, in the displayed list, the recorded video image that the user wishes to display. When a “LOGOUT” button 413 is pressed, a list of another imaging device 110 (not illustrated) is displayed, so that the user can select the video image of the imaging device that the user wishes to display in the video image area 410.

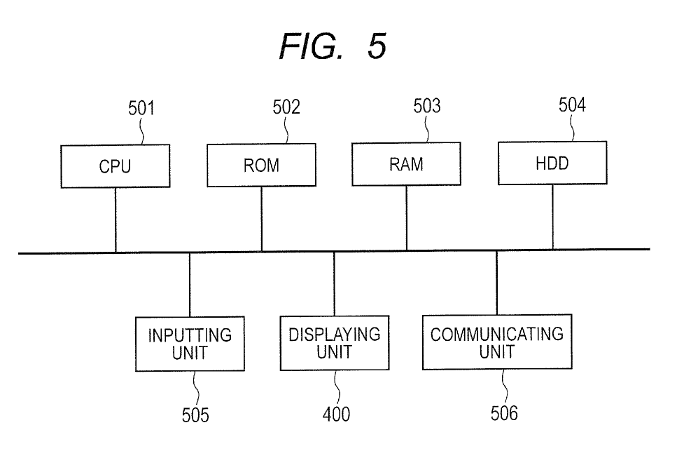

FIG. 5 is a block diagram for describing the constitution of the terminal device 120. The terminal device 120 comprises a CPU 501, a ROM (read only memory) 502, a RAM (random access memory) 503, an HDD (hard disk drive) 504, an inputting unit 505 and a communicating unit 506, in addition to the displaying unit 400. The CPU 501 performs various processes by reading the control program stored in the ROM 502. Besides, the RAM 503 is used as the main memory of the CPU 501, and a temporary storage area such as a working area or the like. The HDD 504 is used to store various data, various programs, and the like. Incidentally, it should be noted that later-described functions and processes of the terminal device 120 are realized on the premise that the CPU 501 reads out programs stored in the ROM 502 and/or the HDD 504 and executes the read programs. The inputting unit 505, which comprises a keyboard and a mouse, accepts various operations by the user. The communicating unit 506 performs a communicating process with an external apparatus via the network 140. Incidentally, it should be noted that the hardware constitution of the VMS 130 is the same as the hardware constitution of the terminal device 120.

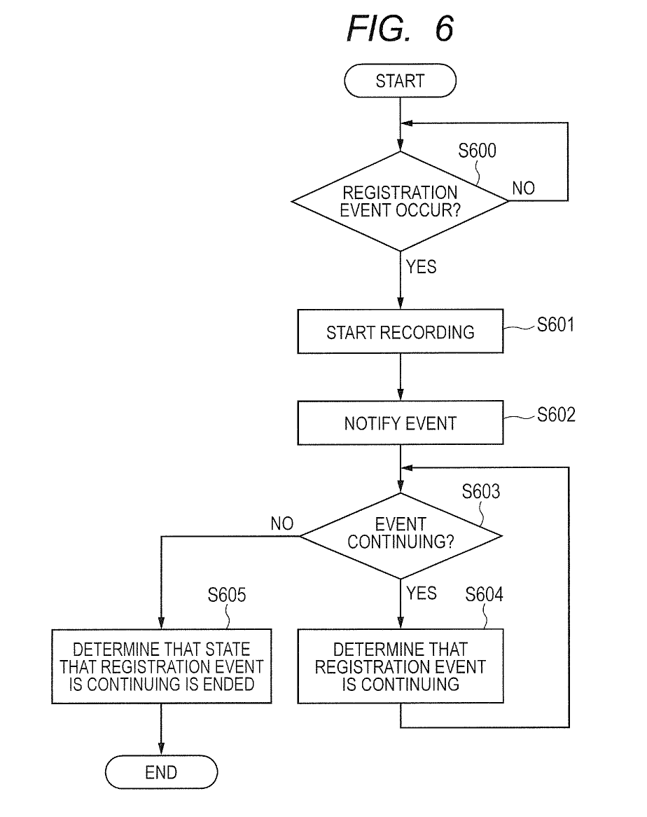

FIG. 6 is a flow chart for describing a state determining process by the imaging device 110. In the state determining process, the CPU 214 determines the state of the registration event. Incidentally, the state of the registration event includes two states, that is, a state that the registration event is continuing, and a state that the registration event does not occur. It is assumed that the state of the registration event is set to a state that no registration event occurs, as the initial state.

Initially, in 5600, the determining unit 301 determines whether or not the registration event occurs. More specifically, the determining unit 301 determines whether or not the registration event occurs, based on the detection result of the detecting circuit 213 in accordance with a predetermined occurrence determination condition. Here, it is assumed that the occurrence determination condition is defined for each registration event. The occurrence determination condition is based on the captured image. Further, the occurrence determination condition may refer not only to the captured image but also to the detection result by the sensor. For example, the occurrence determination condition of the carrying-away detection is that, in the captured image, the carrying-away is determined when a movement of the object being the carrying-away target is detected. When it is determined that the registration event occurs (YES in S600), the determining unit 301 advances the process to S601. On the other hand, when it is determined that the registration event does not occur (NO in S600), the determining unit 301 continues the process of S600.

In S601, the recording processing unit 302 sets, as a start time point, the time before the predetermined specific time from the time point at which it is determined that the registration event occurred, and instructs the recording circuit 206 to start the recording of the captured image obtained by the imaging unit 201 from the set start time point. In response to this, the recording circuit 206 starts recording the captured image on the storage medium 207 as a storing unit. Incidentally, when the recording circuit 206 constantly performs the recording, the recording processing unit 302 only has to record, in the recording circuit 206, the time before the predetermined specific time from the time point at which it is determined that the registration event occurred, as the start time point.

In S602, the output processing unit 304 controls to transmit an occurrence notification indicating the occurrence of the registration event to the terminal device 120 via the communicating circuit 210. The output processing unit 304 controls to transmit the occurrence notification to, for example, the terminal device 120. It is assumed that the terminal device 120 to which the occurrence notification is transmitted is the terminal device 120 of a registration user who has previously been registered to the imaging device 110. On another front, the communicating circuit 210 outputs the occurrence notification. As just described, the imaging device 110 outputs the occurrence notification when the predetermined event occurs.

Next, in S603, the determining unit 301 determines whether or not the registration event of which the occurrence was determined in S600 is continuing. The determining unit 301 performs the determination based on the detection result of the detecting circuit 213, by referring to a predetermined continuation determination condition. Incidentally, in case of determining whether or not the registration event is continuing, the determining unit considers not only whether or not the registration event is continuing, but also whether or not the related event related to the registration event is continuing. For example, with respect to the registration event “carrying-away detection”, when the corresponding related event “detection of the person who carried the object away” occurs and is continuing, the determining unit 301 determines that the registration event is continuing.

When the determining unit 301 determines that the registration event is continuing (YES in S603), the determining unit advances the process to S604. On the other hand, when the determining unit 301 determines that the registration event does not continue (NO in S603), the determining unit advances the process to S605.

In S604, the determining unit 301 determines that the registration event is continuing, and then returns the process to S603. On the other hand, in S605, the determining unit 301 determines that the state that the registration event is continuing ends and thus the registration event does not occur. After then, the determining unit returns the process to S600. It is assumed that the state determining process is continuously and repeatedly performed.

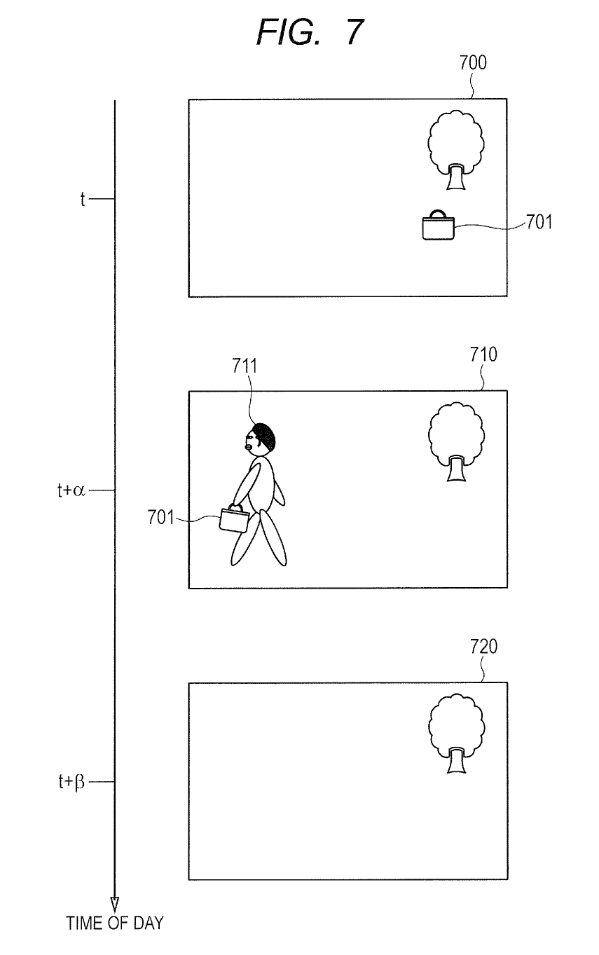

Hereinafter, with reference to FIG. 7, the state determining process will concretely be described using the registration event “carrying-away detection” as an example. Frame images 700, 710 and 720 in FIG. 7 are frame images included in the captured image. It is assumed that these images are obtained at times t, t+α, t+β (β>α), respectively. Incidentally, an object 701 of the frame image 700 is an object to which the carrying-away detection is to be performed. The determining unit 301 surveils the object 701, and, when the movement of the object 701 is detected, determines that the carrying-away detection occurs. Further, as in the case of the frame image 710, while a moving body (person) 711 moving with the object 701 is existing in the captured image, the determining unit 301 determines that the registration event is in a state of continuation. Then, as in the case of the frame image 720, when the moving body 711 disappears from the captured image, the determining unit 301 determines that the state that the registration event is continuing ends.

In the imaging device 110, with regard to the continuation of the event of “carrying-away detection”, the continuation determination condition is assumed to be set as follows. Namely, when any one of the following conditions 1 and 2 is satisfied, it is determined that the event is continuing.
Condition 1: the object for which the carrying-away detection is performed (the target object of the carrying-away detection) has been carried away.
Condition 2: in the captured image, the moving body is detected, or the moving body is detected in the area of the target object of the carrying-away detection, and, after the detection of the moving body, the detected moving body exists in the captured image.

When any one of the conditions 1 and 2 is satisfied, the determining unit 301 determines that the event is continuing.

In the condition 2, in regard to the determination as to whether or not the detected moving body exists in the captured image, it is assumed that, when the moving body is detected, the detecting circuit 213 tracks the detected moving body. Incidentally, after the detection of the moving body in the area of the target object of the carrying-away detection in the condition 2, the area for tracking the relevant moving body may be separately set in the vicinity of the target object. This is because, in the case where the target object of the carrying-away detection is actually carried away, in the area of the carrying-away detection of the target object, there is a case where the moving body detection for tracking cannot be performed if, for example, an object put on a shelf is carried away.

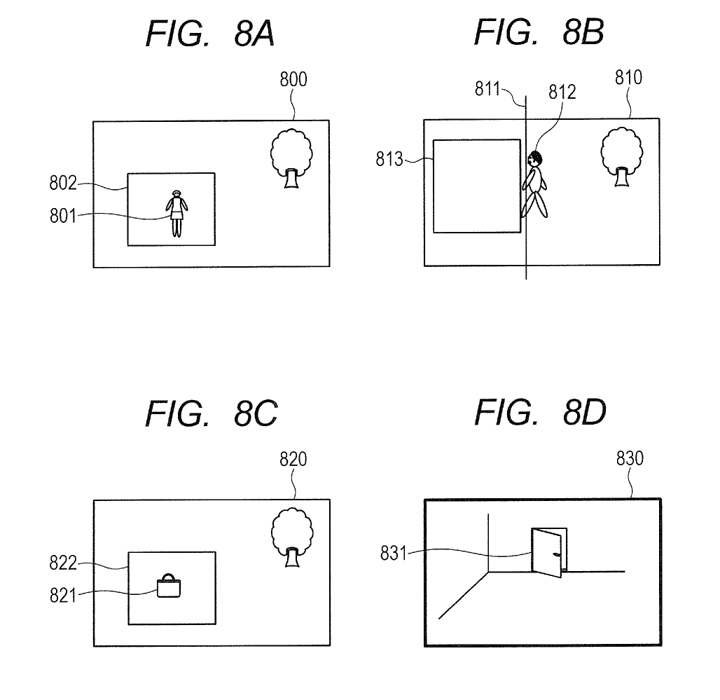

FIGS. 8A to 8D are explanatory diagrams of the continuation determination condition related to registration events other than the carrying-away detection. FIG. 8A is the explanatory diagram of the continuation determination condition for determining whether or not an event corresponding to the registration event “intrusion detection” is continuing. In a frame image 800, when an intruding object 801 is detected, the event of the intrusion detection occurs. The continuation determination condition corresponding to “intrusion detection” is that the event is determined to be continuing in case of the state “the event of the intrusion detection state is continuing”.

In case of confirming what the intruding object is, the detecting circuit 213 tracks the intruding object, that is, the moving body coming out of an intrusion detection area 802 even after the end of the intrusion detection state. Then, the determining unit 301 can determine that the event is continuing in case of the state that the intruding object is within the video image.

FIG. 8B is the explanatory diagram of the continuation determination condition for the registration event “passage detection”. In a frame image 810, when a moving body 812 passing from the right to the left across a line 811 is detected, the event of the passing detection occurs. The continuation determination condition corresponding to “passage detection” is that the event is determined to be continuing in case of the state “the detected object is tracked and in the video image”.

As another example of the continuation determination condition, the event may be determined to be continuing in case of the state “the detected object exists in a setting area provided for performing moving body detection”. For example, in the example of FIG. 8B, a setting area 813 is the area on the left side of the line 811. The setting area 813 is the range which is defined on the basis of the line 811.

FIG. 8C is the explanatory diagram of the continuation determination condition for the registration event “leaving-behind detection”. In a frame image 820, when a new object 821 is detected, the event of the leaving-behind detection occurs. The continuation determination condition corresponding to “leaving-behind detection” is that the event is determined to be continuing in case of the state “the event of the leaving-behind detection is continuing”.

As another example of the continuation determination condition, the event may be determined to be continuing in case of the state “the moving body went out of the leaving-behind detection area is tracked and the tracked moving body is within the video image”. For example, in the example of FIG. 8C, a detection area 822 is set with reference to the detection position of the object 821.

FIG. 8D is an explanatory diagram of the continuation determination condition for the registration event “door opening detection”. Here, a frame image 830 includes a detection-target door 831. A sensor is attached to the detection-target door, and a door opening signal is input to the sensor inputting unit 212 when the door is opened. The detecting circuit 213 detects the opening of the door based on the input signal. The continuation determination condition corresponding to “door opening detection” is that the event is determined to be continuing in case of the state “the moving body is detected in the video image”. This is to determine whether or not there is a person who has opened the door and intruded.

As another example, a moving body detection area may be limited. Besides, there is a case where an intruder from the door generates sound. In the case like this, it may be possible to set the state “the voice information input from the sensor inputting unit 212 via the microphone and indicating the sound volume equal to or higher than a setting value continues to be detected” as the continuation determination condition. The input from the sensor inputting unit 212 is not limited to the sound from the microphone. Namely, other examples of this input include scream detection, loud sound detection, and the like.

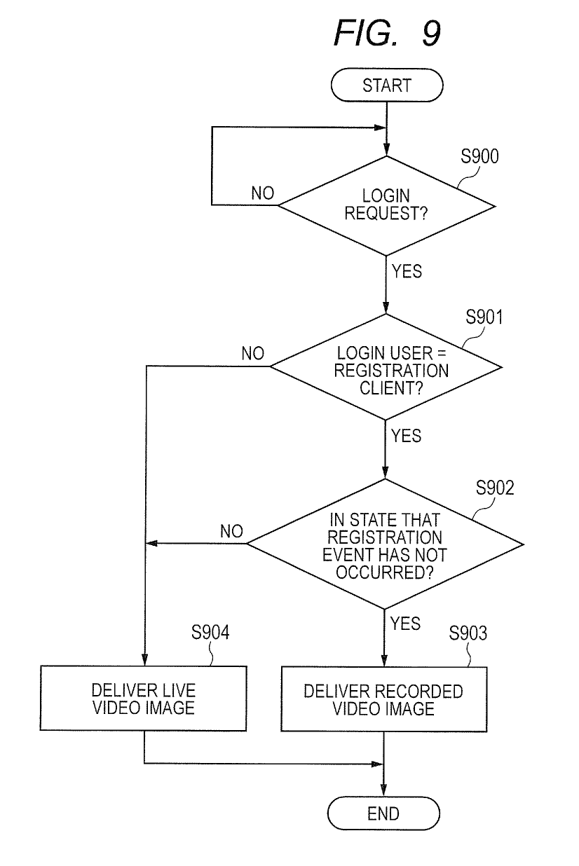

FIG. 9 is a flow chart for describing a delivering process to be performed by the imaging device 110. In S900, the accepting unit 303 confirms whether or not a login request is accepted from the terminal device 120 via the communicating circuit 210. When the login request is accepted (YES in S900), the accepting unit 303 advances the process to S901. On the other hand, when the login request is not accepted (NO in S900), the accepting unit 303 continues the process of S900. Incidentally, the login request is an example of an output instruction of the captured image.

In S901, the output processing unit 304 confirms whether or not the terminal device 120 being the transmission source of the login request (login user) is the terminal device 120 of the registration user (registration client). When the terminal device being the transmission source of the login request is the terminal device 120 of the registration user (YES in S901), the output processing unit 304 advances the process to S902. On the other hand, when the terminal device being the transmission source of the login request is not the terminal device 120 of the registration user (NO in S901), the output processing unit 304 advances the process to S904.

In S902, the output processing unit 304 confirms the state of the registration event. It should be noted that the state of the registration event is determined in the above state determining process. In the state that the registration event has not occurred (YES in S902), the output processing unit 304 advances the process to S903. On the other hand, in the state that the registration event is continuing (NO in S902), the output processing unit 304 advances the process to S904. This process is a process of confirming whether or not the registration event occurs when the login request as the output instruction is accepted.

In S903, the output processing unit 304 controls to deliver the recorded video image as the captured image, together with information indicating the recorded video image, to the terminal device 120 being the request source of the login request. More specifically, the output processing unit 304 instructs the selecting circuit 208 to select the recorded video image. In response to the instruction, the selecting circuit 208 selects the recorded video image. The recorded video image is transmitted to the terminal device 120 via the communicating circuit 210 and the like. Incidentally, the recorded video image transmitted in S903 is a video image captured while the registration event is continuing. In the present embodiment, as described above, the recorded video image is the video image between the start time point before the specific time from the time point of the occurrence of the event and the end time point of the end of the state that the registration event is continuing. As just described, in the case where the registration event does not continue, since the recorded video image is delivered, the user can confirm the situation of the registration event. Incidentally, even in a case where the registration event is not continuing, the live video image may be delivered after a predetermined time elapses from the occurrence of the event. The reason for doing so is because it is considered that the user does not attempt to obtain a video image with the occurrence of the registration event as an opportunity. Besides, the live video image may be delivered to the user who transmitted the occurrence notification. The reason for doing so is also because it is considered that the user does not attempt to obtain a video image with the occurrence of the registration event as an opportunity.

Incidentally, the output processing unit 304 of the present embodiment sets the recorded video image from the registration event occurrence time point to the registration event end time point as the delivery target. However, the period of the recorded video image to be delivered is not limited to that described in the present embodiment. For example, it may be possible to set a video image for a preset time from the event occurrence time point as the delivery target.

As another example, in S903, the output processing unit 304 may deliver the recorded video image after outputting the live video image for a certain period of time. Thus, the user can confirm the situation of the event being continuing after confirming the situation at the delivery time point.

In S904, the output processing unit 304 controls to deliver the live video image as the captured image, together with information indicating the live video image, to the terminal device 120 being the request source of the login request. More specifically, the output processing unit 304 instructs the selecting circuit 208 to select the live video image. In response to the instruction, the selecting circuit 208 selects the live video image. The live video image is transmitted to the terminal device 120 via the communicating circuit 210 and the like. As just described, since the live video image is delivered when the registration event is continuing, the user can confirm the situation of the delivery time point related to the registration event. Incidentally, the live video image is an example of the captured image captured after the time point of accepting the login request as the output instruction.

In this manner, the imaging device 110 can switch between the recorded image and the live image depending on whether or not the registration event is continuing, and transmit the switched image to the terminal device 120. Thus, the user can confirm the occurred registration event immediately after he/she logs in from the terminal device 120 to the imaging device 110. Therefore, the user can quickly respond to the registration event.

An optimum surveillance environment differs depending on a surveillance condition. More specifically, the optimum surveillance environment in the condition that surveillance is performed at time when there is no person is different from the optimum surveillance environment in the condition that a moving body such as a road or the like constantly existing in the surveilling must be removed from the surveillance target. Therefore, the imaging device 110 is provided with a function enabling to set and change the continuation determination condition for each registration event. Thus, it is possible to perform the continuation determination for the registration event suitable in the imaging job site.

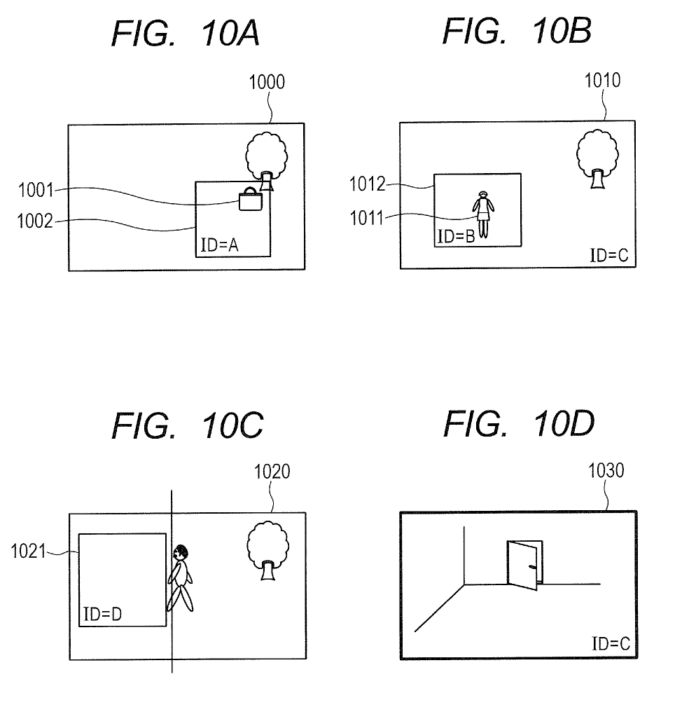

FIGS. 10A to 10D are explanatory diagrams of the continuation determination condition. More specifically, FIG. 10A shows an example of the setting for the carrying-away detection. The user can designate, in a video image 1000, a moving body detection area 1002 for tracking in the vicinity of an object 1001 of the carrying-away detection as the area where the user wishes to track the moving body. Upon accepting a setting instruction according to the user's operation, the imaging device 110 assigns an area ID to the moving body detection area 1002 related to the setting instruction, and sets the moving body detection area 1002 in association with the area ID. Here, it is assumed that the area ID of the moving body detection area 1002 is set to “A”. Incidentally, the user can set the area by drawing a rectangle with a mouse on the video image 1000 by a not-illustrated graphical I/F and setting the area ID.

FIG. 10B shows an example of the setting for the intrusion detection. In the example, it is assumed that the user wishes to surveil an intruder 1011 by tracking even after the intruder went out of an intrusion surveillance area 1012. In this case, in a video image 1010, the user can designate the intrusion surveillance area and the entire video image area. The imaging device 110 assigns an area ID to each of the intrusion surveillance area and the entire video image area, and sets the entire area in association with the area ID. Here, the area IDs of the intrusion surveillance area and the entire video image area are “B” and “C”, respectively.

FIG. 10C shows an example of the setting for the passage detection. In a video image 1020, the user can designate a moving body detection area 1021. The imaging device 110 sets the moving body detection area 1021 in association with the area ID “D”. FIG. 10D shows an example of the setting for the door opening detection (door-open state detection). In the example, it is assumed that the user wishes to surveil whether or not a moving body exists in a video image 1030 after the open of the door. In this case, the user can designate the entire video image as the moving body detection area in the video image 1030. The imaging device 110 sets the entire video image area as the moving body detection area in association with the area ID “C”.

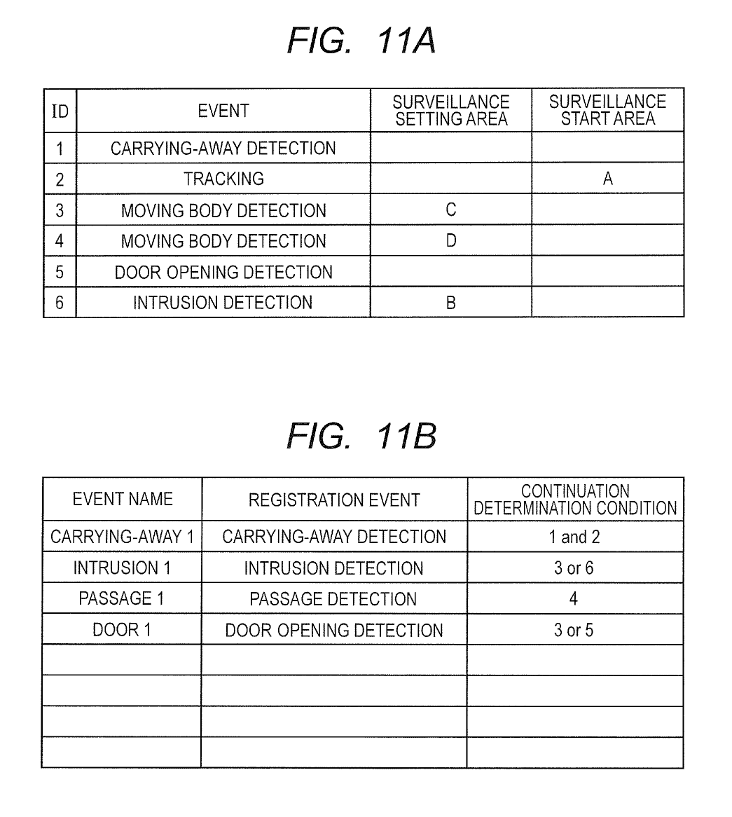

FIG. 11A is a diagram for describing the surveillance conditions of the events corresponding to FIGS. 10A to 10D in a table format. The surveillance conditions are previously stored in the storing unit of the imaging device 110. In the column of “ID”, the event IDs of the events which can be surveilled by the imaging device 110 are shown. In the column of “event”, the events which can be surveilled by the imaging device 110 are shown. Incidentally, even for the events of the same kind, it is possible to register these events with different surveillance targets and conditions by changing the respective names such as “carrying-away detection 1” and “carrying-away detection 2”. In the column of “surveillance setting area”, the area IDs of the areas set as the surveillance areas are shown. In the column of “surveillance start area”, the area ID of the surveillance start area for the event of the column of “event” is shown.

The “carrying-away detection” of the event ID “1” indicates that the carrying-away detection state shown in FIG. 10A is continuing, and the “tracking” of the event ID “2” indicates that the tracking start area shown in FIG. 10A is started from the area of the ID “A”. The “moving body detection” of the event ID “3” indicates the moving body detection area (the whole video image) of the ID “C” in the intrusion detection of FIG. 10B and the door opening detection of FIG. 10D. The “moving body detection” of the event ID “4” indicates the moving body detection area 1021 in the passage detection of FIG. 10C. The “door opening detection” of the event ID “5” indicates the state that the door opening state in the door opening surveillance of FIG. 10D is continuing. The event ID “6” indicates that the intrusion surveillance area 1101 is set in the intrusion detection of FIG. 10B.

Incidentally, it should be noted that the events shown as the surveillance condition include not only the registration event but also the related event. For example, the surveillance condition for the moving body detection is the condition which is applied not only to the moving body detection for the object being the detection target of the carrying-away detection as the registration event but also to the moving body detection for the person who carried the object away.

FIG. 11B is a diagram showing the continuation determination conditions in a table format. The continuation determination conditions are previously stored in the storing unit of the imaging device 110. In the column of “event name”, the names of the registration events set in the imaging device 110 are shown. Incidentally, the name of the registration event can arbitrarily be set by the user or the like. In the column of “registration event”, the kinds of registration events are shown. In the column of “continuation determination condition”, the condition expressions in which the conditions such as “and”, “or”, “nand”, “not” and the like are set for the respective surveillance conditions described with reference to FIG. 11A are shown.

In the event name “carrying-away 1”, the carrying-away detection is the trigger for the continuation determination. When the conditions of the event IDs “1” and “2” shown in FIG. 11A simultaneously occur in the column of “continuation determination condition”, it is determined that the event is continuing. In the even name “intrusion 1”, the intrusion detection is the trigger for the continuation determination. When either the event of the event ID “3” or the event of the event ID “6” is surveilled, it is determined that the event is continuing. In the event name “passage 1”, the passage detection is the trigger for the continuation determination. When the event of the event ID “4” is surveilled, it is determined that the event is continuing. In the event name “door 1”, the door opening detection is the trigger for the continuation determination. When the event of the event ID “3” or “5” is surveilled, it is determined that the event is continuing.

In the imaging device 110, also the continuation determination condition for each registration event as shown in FIG. 11B can be set and changed according to the user's operation. Thus, it is possible to perform the appropriate continuation determination suitable in the imaging job site. As described above, the imaging device 110 according to the present embodiment can switch the delivery target image between the live video image and the recorded video image, depending on whether or not the registration event is continuing. That is, when a predetermined event occurs, the imaging device 110 can output the captured image suitable for confirming the event.

A first modified example of the imaging system according to the present embodiment will be described. The unit which performs the operation of the state determining process described with reference to FIG. 6 and the unit which performs the operation of the delivering process described with reference to FIG. 9 are not limited to the imaging device 110. As another example, these processes may be performed by the terminal device 120 or the VMS 130.

When the terminal device 120 performs the process, the imaging device 110 always transmits the live video image output from the encoding circuit 205 to the terminal device 120. The terminal device 120 performs the process by inquiring the imaging device 110 about the past state. Then, the terminal device 120 switches the captured image to be displayed on the displaying unit 400 between the live video image and the recorded video image.

Besides, when the VMS 130 performs the process, the imaging device 110 always transmits the live video image output from the encoding circuit 205 to the VMS 130. Then, the VMS 130 switches the captured image to be delivered to the terminal device 120, between the live video image and the recorded video image.

Besides, a plurality of apparatuses may cooperatively perform the processes. For example, the imaging device 110 performs the state determining process and the terminal device 120 performs the delivering process.

Further, as a second modification, the processes of the recording circuit 206, the selecting circuit 208 and the detecting circuit 213 of the imaging device 110 may be performed by the CPU 214.

As described above, according to the above embodiment, when the predetermined event occurs, it is possible to output the captured image suitable for confirming the event.

Although the preferred embodiment of the present invention has been described in detail, the present invention is not limited to the relevant specific embodiment, and various modifications and changes are possible within the scope of the substance of the present invention described in the claims.

### Other Embodiments

It is possible to achieve the present invention also by supplying a program for realizing one or more of the functions of the above embodiment to a system or an apparatus via a network or a storage medium and causing one or more processors in the computer of the system or the apparatus to read and execute the supplied program. Also, it is possible to achieve the present invention by a circuit (e.g., ASIC) for realizing one or more functions of the above embodiment.

According to each of the above embodiments, when the predetermined event occurs, it is possible to output the captured image suitable for confirming the event.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of delivered computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-106365, filed May 27, 2016, which is hereby incorporated by reference herein in its entirety.

What is claimed is:

1. An image outputting apparatus comprising:
a first accepting unit configured to accept an output instruction of a captured image captured by an imaging unit; and
an outputting unit configured to, in a case where, in the captured image captured at a first time point, the output instruction is accepted at a second time point after occurrence of a predetermined event and the predetermined event is continuing at the second time point, output the captured image captured by the imaging unit at and after the second time point, and, in a case where the output instruction is accepted at the second time point and the predetermined event does not continue at the second time point, output the captured image captured during the continuation of the predetermined event.

2. The image outputting apparatus according to claim 1, wherein, in the case where the predetermined event does not continue at the second time point, the outputting unit is configured to output the captured image captured during the continuation of the predetermined event and stored in a storing unit.

3. The image outputting apparatus according to claim 1, wherein
the captured image is a moving image, and
in the case where predetermined event does not continue at the second time point, the outputting unit is configured to output the moving image during the continuation of the predetermined event as the captured image.

4. The image outputting apparatus according to claim 1, wherein, in the case where the predetermined event does not continue at the second time point, the outputting unit is configured to output the captured image captured during the continuation of the predetermined event after outputting, for a certain time, the captured image captured by the imaging unit at and after the second time point.

5. The image outputting apparatus according to claim 1, further comprising a first determining unit configured to determine whether or not the predetermined event is continuing, based on a determination condition.

6. The image outputting apparatus according to claim 5, further comprising a second accepting unit configured to accept a setting instruction of the determination condition, wherein
the first determining unit is configured to perform the determination based on the determination condition related to the setting instruction.

7. The image outputting apparatus according to claim 1, further comprising a second determining unit configured to determine whether or not the predetermined event occurs, based on the captured image.

8. The image outputting apparatus according to claim 7, wherein the second determining unit is configured to determine whether or not the predetermined event occurs, based on a detection result by a detecting unit configured to detect an environmental change according to the predetermined event in an area using an imaging range of the imaging unit as a reference.

9. The image outputting apparatus according to claim 1, wherein, in a case where the predetermined event occurs in the captured image captured at the first time point, the outputting unit is configured to output an occurrence notification indicating the occurrence of the predetermined event.

10. An image outputting method to be performed by an image outputting apparatus, comprising:
accepting an output instruction of a captured image captured by an imaging unit; and
in a case where, in the captured image captured at a first time point, the output instruction is accepted at a second time point after occurrence of a predetermined event and the predetermined event is continuing at the second time point, outputting the captured image captured by the imaging unit at and after the second time point, and, in a case where the output instruction is accepted at the second time point and the predetermined event does not continue at the second time point, outputting the captured image captured during the continuation of the predetermined event.

11. A non-transitory computer-readable storage medium which stores therein a program for causing a computer to function as:
an accepting unit configured to accept an output instruction of a captured image captured by an imaging unit; and
an outputting unit configured to, in a case where, in the captured image captured at a first time point, the output instruction is accepted at a second time point after occurrence of a predetermined event and the predetermined event is continuing at the second time point, output the captured image captured by the imaging unit at and after the second time point, and, in a case where the output instruction is accepted at the second time point and the predetermined event does not continue at the second time point, output the captured image captured during the continuation of the predetermined event.
